(19) United States
(12) Patent Application Publication
(10) Pub. No.: US 2009/0293563 A1
(43) Pub. Date: Dec. 3, 2009

(54) LOCK WITH MULTIPLY CIRCLED CYLINDER

(76) Inventor: Bing-Huei Jeng, Sinjhuang City (TW)

Correspondence Address: G. LINK CO., LTD., 3550 BELL ROAD, MINOOKA, IL, 60447, US

(21) Appl. No.: 12/128,041

(22) Filed: May 28, 2008

(51) Int. Cl. E05B 27/04

(52) U.S. Cl. 70/359

(57) ABSTRACT

A lock with a multiply circled cylinder mainly comprises a lock body and a key. The lock body includes a multiply circled cylinder and a housing receiving the multiply circled cylinder. The multiply circled cylinder assembly further comprises a front rotating shaft, a front shaft seat, a rear rotating shaft and a rear shaft seat. The housing has an outer sleeve and an inner sleeve. The key comprises a large cylindrical key parts, a small cylindrical key part and a central key pole. The front rotating shaft has a plurality of outer locking pins and the rear rotating shaft has a plurality of inner locking pins. The large cylindrical key part has a plurality of teeth corresponding to the outer and inner pins in the front and rear rotating shafts. Hence, the lock with a multiply circled cylinder assembly is capable of being constructed as either the rotary lock or the push-in lock easily.

### BACKGROUND OF THE INVENTION

1. Field of the Invention

The present invention relates to a lock cylinder, and more particularly to a precisely structured lock structure with a multiply circled cylinder capable of being commonly installed on every kind of lock to attain to the burglarproof object.

2. Description of Related Art

There are many different kinds of the conventional locks available on the market such as the flat lock, the pad lock, the tubular lock and etc. However, the lock cylinder for the preceding conventional locks is simply formed by an upper shaft seat, a lower shaft seat and an inner axle body of the housing, and the simple structure the lock cylinder is incapable of preventing a burglar from undoing or destroying the lock body easily to disarm the burglarproof function of the lock.

### SUMMARY OF THE INVENTION

The main object of the present invention is to provide a lock with a multiply circled cylinder, which is a precise structure to perform multiple protection stages against various unlocking tools such that a burglar is unable to undo the lock even with his effort to secure the burglarproof function of the lock.

For attaining to the object mentioned above, a lock proposed in the present invention, mainly comprises a lock body and a key. A multiply circled cylinder assembly is installed in the housing of the lock body and formed with a plurality of coaxial components coupled to each other sequentially. The rear side of the housing extends outward with a lock bolt, and the front side the lock body is disposed with a plurality of concentric partition rings in different diameters to form a plurality of circular grooves in between. A plurality of inner and outer locking pin holes are arranged corresponding to the circular grooves for a plurality of lock pins and locating springs being disposed in the circular grooves through the pin holes. The key has an outer and an inner concentric cylindrical key parts in different diameters with a toothed front end respectively to correspond to the lock pins disposed in the circular grooves between the partition rings. Thereby the multiply circled cylinder assembly according to the present invention is capable of being commonly used in various types of locks for attaining the burglarproof function accurately.

### BRIEF DESCRIPTION OF THE DRAWINGS

The present invention can be more fully understood by reference to the following description and accompanying drawings, in which:

FIG. 1 is a plane view illustrating a lock body and a key of a preferred embodiment of a lock with a multiply circled cylinder according to the present invention;

FIG. 2 is an exploded perspective view showing the parts of the lock body illustrated in FIG. 1 for being used with a rotary lock set;

FIG. 3 is a partly sectional view showing the assembled lock body illustrated in FIG. 2;

FIG. 4 is an exploded perspective view showing the parts of the lock body illustrated in FIG. 1 for being used with a push-in lock set;

FIG. 5 is a partly sectional view showing the assembled lock body illustrated in FIG. 4;

FIG. 6 is an enlarged schematic view of the positioning rod and U-shaped spring shown in FIG. 4 illustrating the positioning grooves on the positioning stem engaging with the U-shaped positioning spring;

FIG. 7 is an enlarged schematic view similar to FIG. 6 showing the positioning grooves disengaging from the U-shaped positioning spring;

FIG. 8 is an exploded perspective view showing the parts of the key of the present invention; and

FIG. 9 is a partly sectional view similar to FIGS. 3 and 5 illustrating a modification for the rear shaft seat 62 and the inner pins 242.

### DETAILED DESCRIPTION OF THE PREFERRED EMBODIMENTS

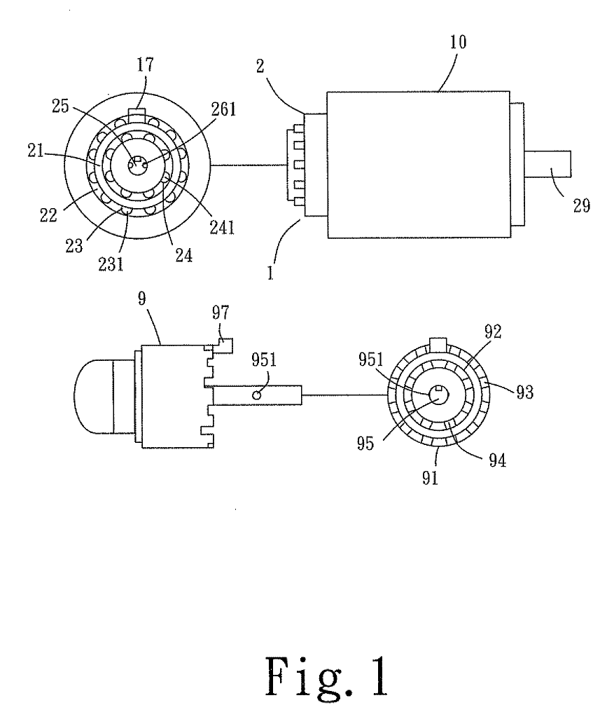

Referring to FIGS. 1, 2 and 3, a lock with a multiply circled cylinder of a preferred embodiment according to the present invention mainly comprises a lock body 1 and a key 9.

A multiply circled cylinder assembly 2 is installed in a housing 10 of the lock body 1; it is constructed by a plurality of coaxial components pivotally coupled to each other in series, a rear side thereof is projected with a bolt 29 and a front side thereof is disposed with a plurality of different diameters of concentric partitioning rings 21 to allow an intermediate space between each two adjacent rings to be formed with a slot 22, in which separated outer and inner circle pin holes 23 and 24 are disposed in the slots 22 and a plurality of springs 20 and pins 231, 232, 241, 242 are installed therein.

A large cylindrical key part 91 and a small cylindrical key part 92 provided at the key 92 are disposed concentrically and the front ends of the key parts 91, 92 have a plurality of teeth 93, 94 corresponding to the pins 231 and 241 disposed in the slots 22.

In practice, a central hole 25 with a magnetic pin 251 radially disposed at the inner wall thereof can be arranged in the multiply circled cylinder assembly 2 and a central shaft 95 can be provided at the key 9 to correspond to the central hole 25. Two opposite magnetic projections 951 are attached to the outer surface of the central shaft 95 to correspond to the magnetic pin 251 such that a magnetic force is yielded between the magnetic pin 251 and the magnetic projections 951 at the time of being positioned next to each other to attract the magnetic pin 251 to a unlock position.

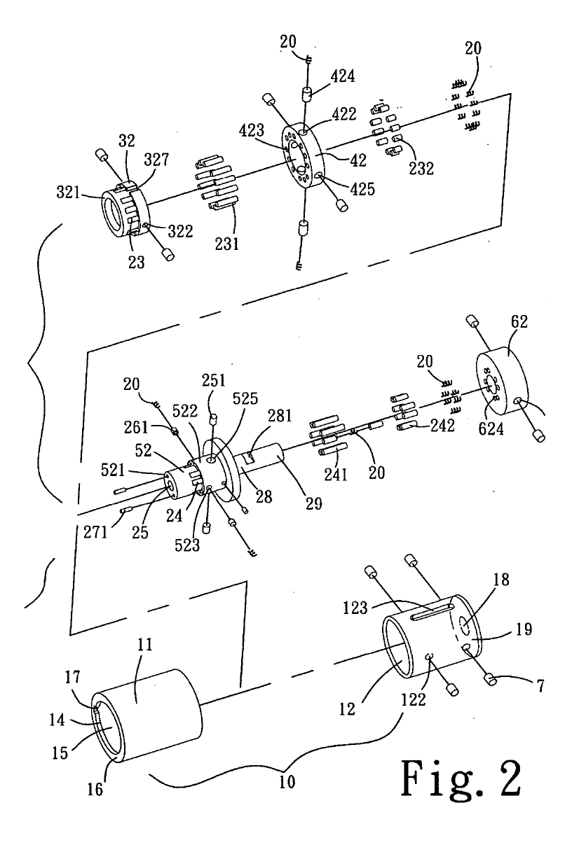

Furthermore, some of the locking pins 241 may be constructed as two cut-short sticks with a spring 20 placed in between as shown in FIG. 2 so as to increase the unlocking difficulty. Alternatively, a functionless deception pin 261 is further installed in the multiply circled cylinder assembly 2 to deceive a thief while the thief trying to open the lock. In addition, a plurality of projecting pins 271 may further be disposed at the front end of the rear rotating shaft 52 of the multiply circled cylinder assembly 2 (see FIG. 2) to prevent from the thief breaking the lock with a drill to allow forcibly.

Referring to FIGS. 1 and 2 again, the housing 10 of the lock body 1 is composed of an inner sleeve 12 and an outer sleeve 11, which fits with the inner sleeve. An inner space 15 of the housing 10 accommodates the multiply circled cylinder assembly 2, and the rear side of the inner sleeve 12 has a plate-shaped sealing cap 19 with a central through hole 18 and the front side of the outer sleeve 11 has an opening 14 with a blocking ring 16, which has a reduced inner diameter. A positioning notch 17 is disposed at the blocking ring 16. Furthermore, the key 9 has a positioning projecting piece 97 extending forward from one of the teeth at the large cylindrical key part 91 and corresponding to the positioning notch 17 for the key 9 capable of inserting into the lock body 1 accurately.

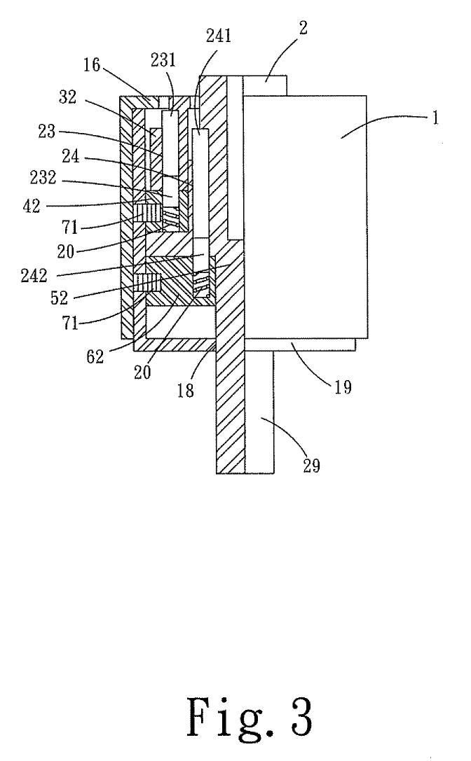

Referring to FIG. 3 accompanying FIG. 2 again, the multiply circled cylinder 2 mainly includes a front rotating shaft 32, a front shaft seat 42, a rear rotating shaft 52 and a rear shaft seat 62. The front rotating shaft 32 is a hollow stepped cylindrical piece with the largest outer circumference thereof being slightly smaller than the inner circumferential side of the inner sleeve 12 such that the front rotating shaft 32 is capable of moving in the inner sleeve 12. A projecting step 321 extends forward from the front rotating shaft 32 with a reduced outer circumference. A plurality of axial outer locking pin holes 23 are disposed near the rim of the rear side of the front rotating shaft 32 and extend forward to the projecting step 321. It can be seen in FIG. 2 that the respective outer pin hole 23 at the projecting step 321 is an elongated semicircular groove such that a plurality of pins 231 are capable of passing through the outer locking pin holes 23 with the front section of the respective pin 231 retained at the semicircular groove. Furthermore, a fitting notch 327 is axially disposed at the circumferential side of the front rotating shaft 32 corresponding to the positioning notch 17 at the blocking ring 16 of the outer sleeve 11, and two retaining holes 322 are radially disposed at the circumferential side of the front rotating shaft 32 without interfering with the outer pin holes 23.

The front shaft seat 42 is a collar with an outer circumferential side thereof well matching the inner circumferential side of the inner sleeve 12 of the housing 10. A plurality of inner axial pin holes 423 respectively corresponding to the outer pin holes 23 are circularly disposed at the front shaft seat 42 to enable the locking pins 232 and the springs 20 to be received therein. Furthermore, two radial pin holes 422 are further disposed oppositely at the circumference of the front shaft seat 42 without interfering with the inner pin hole 423 so as to allow the locking pins 424 and the springs 20 to be respectively disposed therein. Two retaining holes 425, which are oppositely disposed at the circumference of the front shaft seat 42 and equally space part from the radial pin holes 422, are further provided for fixing the front shaft seat 42 to the inner sleeve 12 of the housing 10.

The rear rotating shaft 52 is provided with three step sections in different diameters. The front step section 521 with the smallest diameter has a central locking hole 25. The middle step section 55 has a larger outer diameter to fit with both the central bores of the front shaft seat 42 and the front rotating shaft 32. The rear step section with the largest outer diameter extends rearward a positioning stem 28 and the rear end of the positioning stem 28 is formed a bolt 29. Furthermore, a plurality of axial inner pin holes 24 penetrate the middle step section 522 from the rear side of the rear step section and extend to the front step section 521. The respective pin hole 24 becomes an open semicircular groove at the front step section 521. The locking pins 241 pass through the inner pin holes 24 for enabling the easy assembly and the economical assembly space. Two radial pin holes 523 are disposed oppositely at the circumference of the middle step section 522 to allow a deception pin 261 to be installed therein respectively. Two radial pin holes 525 for respectively receiving the magnetic pins 251 are disposed oppositely at the circumference of the middle step section 522 corresponding to the front shaft seat 42. It is noted that the radial pin holes 525 space apart from the radial pin holes 523 an angular distance of 90 degrees.

The rear shaft seat 62 is a collar with an outer circumferential side thereof fitting with the inner circumferential side of the inner sleeve 12 of the housing 10, and a central fitting bore of the rear shaft seat 62 is passed through with a positioning stem 28 of the rear rotating shaft 52. A plurality of inner axial pin holes 624 provided at the rear shaft seat 62 extend inward from the front side of the rear shaft seat 62 to correspond to the inner pin holes 24 of the rear rotating shaft 52 for accommodating the locking pins 242 and the springs 20. Furthermore, two radial retaining holes 625 are disposed oppositely at the circumferential side of the rear shaft seat 62 for the rear shaft seat 62 being able to be attached to the inner sleeve 12 of the housing 10.

Furthermore, four radial retaining holes 122 are disposed oppositely at the inner sleeve 12 of the housing 10 as shown in FIG. 2 such that the front shaft seat 42 and the rear shaft seat 62 can be secured to the inner sleeve 12 by means of the radial retaining holes 122 aligning with the radial retaining holes 425, 625 and being fastened to each other with screws when the lock body is a rotary lock.

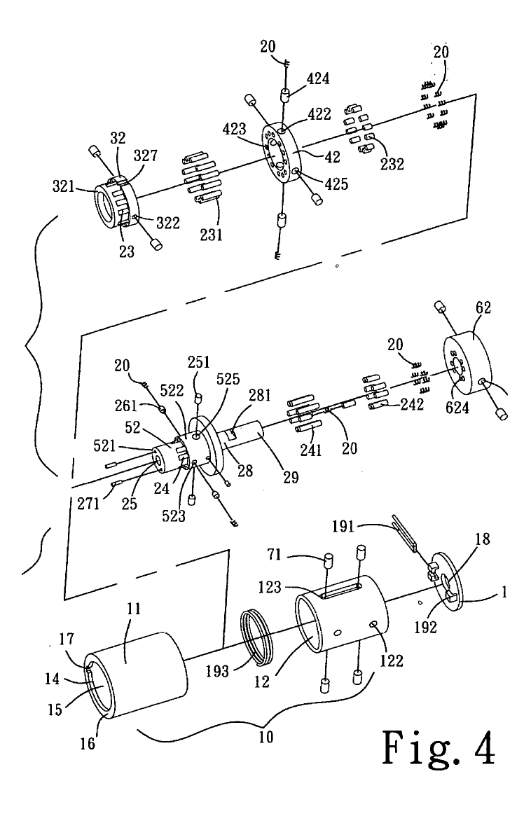

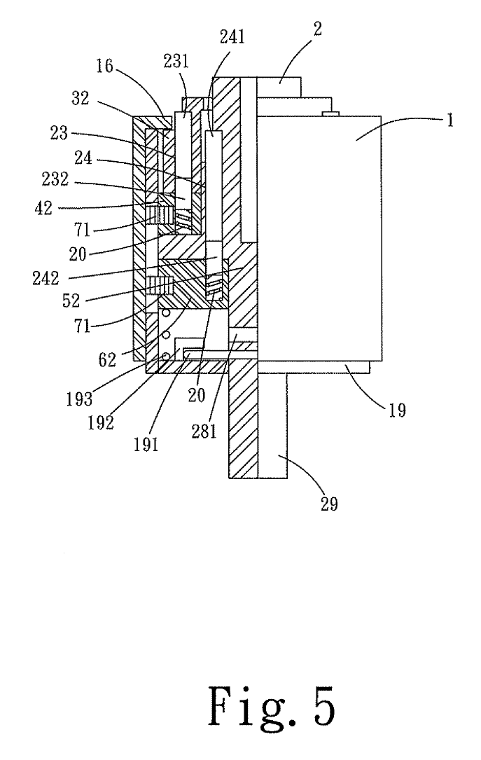

Besides, referring to FIGS. 4 and 5, two slots 123 are oppositely disposed at the inner sleeve 12 in addition to the radial retaining holes 122 such that the front shaft seat 42 and the rear shaft seat can engage with the inner sleeve 12 by means of the retaining holes 425, 625 aligning with the slots 123 and being secured with screws 71 when the lock body is a push-in lock.

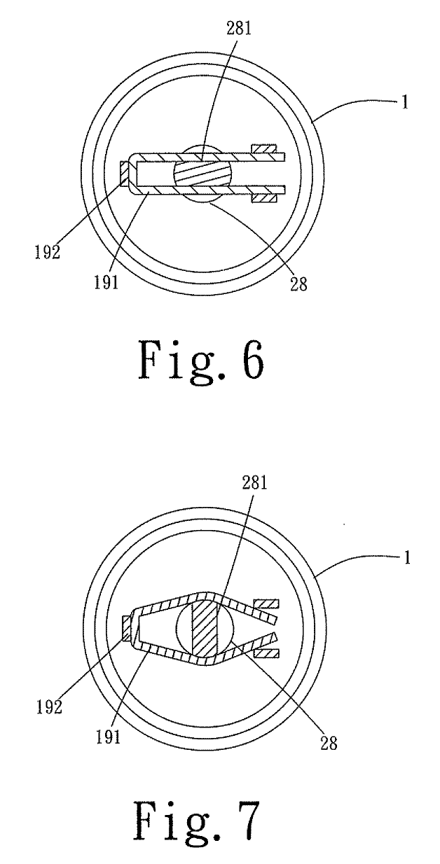

Referring to FIGS. 4 to 7, when the push-in lock is constructed, two opposite positioning grooves 281 must be further disposed at the circumferential side of the positioning stem 28, and a supporting spring 193 may further disposed between the housing 10 and the multiply circled cylinder 2. A plurality of locating hooks are disposed at the rear sealing cap 19 of the inner sleeve 12 for locating the closed end and the open end of a U-shaped positioning spring 191. In addition, the middle portion of the positioning spring 191 engages with the positioning grooves 281 of the positioning stem 28. When the multiply circled cylinder assembly 2 is pressed rearward, it results in the positioning grooves 181 engaging with the positioning spring 191 as shown in FIG. 6 and the lock body is in a state of locking. It is noted that a coil-shaped supporting spring 193, which is disposed in the inner sleeve 12 between the sealing cap and the rear shaft seat, is compressed during the state of locking. When the multiply circled cylinder assembly 2 is turned for unlocking, it results in the positioning grooves 181 disengaging from the positioning spring 191 and the multiply circled cylinder 2 moves back to the original position by means of the restoring force of the supporting spring 193.

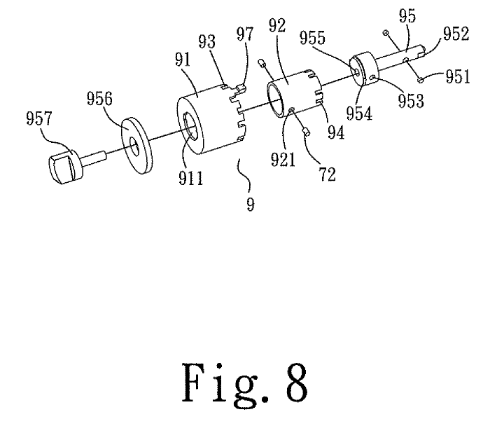

Referring to FIG. 8, the key 9 includes a large cylindrical key part 91, a small cylindrical key part 92 and a central key pole 95, and the three key parts 91, 92, 95 are engaged with each other sequentially. The large cylindrical key part 91 has an open front end with a plurality of teeth 93 corresponding to the outer pins 231 of the front rotating shaft 32, and a closed rear end with a locating hole 911. The small cylindrical key part 92 has an open front end with a plurality of teeth 94 corresponding to the inner pins 241 of the rear rotating shaft 52 and an open rear end with two opposite positioning holes 921 disposed at the circumference of the small cylindrical key part 92 next to the rear end for engaging with the screws 72. The central key pole 95 has the front end thereof disposed with a direction positioning groove 952, the middle part thereof is embedded with the magnetic projections 951 mentioned above, and the rear end thereof being an enlarged diameter fitting head. Two opposite radial retaining holes 953 are disposed at the circumferential side of the fitting head corresponding to the positioning holes of the small cylindrical key part 92, and the rearmost end rim of the fitting head is disposed with a shallow positioning step 954 for engaging with the locating hole 911 at the rear end of the large cylindrical key part 91. Further, a central screw hole 955 is disposed at the rearmost end of the fitting head for the large and small cylindrical key parts 91, 92 capable of engaging with the central key pole 95 with a washer 956 and a bolt 957.

When the key 9 is inserted into the lock body 1 and turned to align with the outer pins 231 and the inner pins 241 of the multiply circled cylinder 2, the rear rotating shaft 52 is released to rotate with the key 9. If it is a rotary lock, the bolt 29 at the rear end of the rear rotating shaft 52 capable of turning a mechanism (not shown) connected to a rear side of the lock body 1, and if it is a push-in lock, the bolt 29 is capable of springing outward and disengaging from an engagement hole (not shown in the figure).

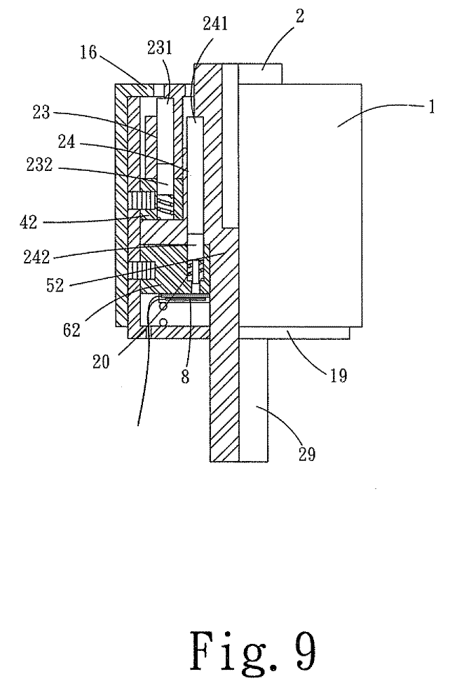

Referring to FIG. 9, in order to reinforce the function of anti-burglary, each of the inner pin holes 624 of the rear shaft seat 62 extends rearward a small counter-taper through hole and each of the pins 242 extends rearward a counter-taper sub-pin section corresponding to the taper hole. Further, a contact switch 8 is disposed behind the counter-taper through hole at the rear side of the rear shaft seat 62. Under this circumstance, the sub-pin section at the tail end of the respective pin 242 is capable of projecting out of the taper hole behind the inner pinhole 624 and pressing the contact switch 8 to cause an alarm (not shown in the figure) externally connected to the contact switch 8 to emit a warning when a burglar tries to undo the lock but misaligns the lock.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1-2. (canceled)

3. A lock with a multiply circled cylinder comprising:
a lock body having a multiply circled cylinder assembly and a housing containing said multiply circled cylinder assembly; and
a key being capable of being inserted into said lock body to unlock said lock body;
wherein said multiply circled cylinder assembly further comprises:
a front rotating shaft being a hollow cylindrical stepped piece with a main cylindrical part and a reduced diameter projecting step extending forward from said main cylindrical part and having a first inner diameter, wherein a plurality of first axial pin holes are disposed to penetrate said main cylindrical part axially and extend to the circumference of said projecting step as a plurality of first circular grooves for accommodating a plurality of first locking pins, and two opposite first radial retaining holes pass through the circumference of said main cylindrical part;
a collar-shaped front shaft seat being disposed next to said front rotating shaft, having a second inner diameter the same as said first inner diameter and having a first outer circumferential side, wherein a plurality of second axial pin holes penetrate said front shaft seat to correspond to said first axial pin holes for receiving a plurality of second locking pins, two opposite second radial pin holes and two opposite first retaining holes disposed at the first circumferential side in such a way of equally spacing apart from each other;
a rear rotating shaft being a cylindrical piece, having a front step section with a first outer diameter, a middle step section with a second outer diameter and a rear step section with a third outer diameter, wherein said second outer diameter is greater than said first outer diameter and less than said third outer diameter, a central locking hole is disposed to extend to said rear step section from said front step section, said second outer diameter is the same as said first and second inner diameters for said middle step engaging with said front rotating shaft and said front shaft seat, said rear step section extends rearward a central positioning stem, a plurality of third axial pin holes penetrate both said rear step section and said middle step section and extending to the circumference of said front step section as a plurality of second circular grooves such that a plurality of third locking pins are capable passing through said third axial pin holes and retained at said second circular grooves, two opposite third radial pin holes are disposed at said middle step section for receiving a deception pin respectively, and two opposite fourth radial pin holes are disposed at said middle step section for receiving a magnetic pin respectively; and
a collar-shaped rear shaft seat having an central fitting hole being passed through with said positioning stem and having a second outer circumferential side being the same as said first outer circumferential side, wherein a plurality of fourth axial pin holes penetrate said rear shaft seat to correspond to said third axial pin holes, and two opposite second radial retaining holes being disposed at the circumference of said rear shaft seat for being secured to said housing.

4. The lock with a multiply circled cylinder according to claim 3, wherein said key comprises:
a large cylindrical key part with a first front end and a first rear end, wherein said first front end is an open end disposed with a plurality of first teeth corresponding to said first locking pins and said first rear end is a closed end disposed with a locating hole;
a small cylindrical key part with a second front end and a second rear end, wherein said second front end is an open end disposed with a plurality of second teeth corresponding to said third axial locking pins, said second rear end is an open end and a plurality of positioning holes are disposed at the circumference of said small cylindrical key next to said second rear end; and
a central key pole with a third front end, a middle part and a third rear end, wherein said third front end is disposed with a direction positioning groove, said middle part is embedded with a plurality of magnetic projections, said third rear end is an enlarged diameter fitting head with a plurality of third radial retaining holes disposed at the circumference of said fitting head corresponding to said positioning holes of said small cylindrical key part, a shallow positioning step being disposed at the rim of a rearmost end of said fitting head to engage with said locating hole, and with a screw hole disposed at the center of said rearmost end for said large and small cylindrical key parts being joined to each other with a washer and a secure bolt.

5. The lock with a multiply circled cylinder according to claim 3, wherein the housing further comprises:
an inner sleeve receiving said multiply circled cylinder assembly, having a first inner circumferential side matching said first and second outer circumferential sides for fitting with said front shaft seat and rear shaft seat, having a plate-shaped rear end sealing cap with a central through hole for said positioning stem capable of extending outward said inner sleeve via said through hole; and
an outer sleeves fitting with said inner sleeve and having a blocking ring integrally joined to the front end thereof, wherein said blocking ring has a second inner circumferential side smaller than said first inner circumferential side for preventing said multiply circled cylinder assembly from moving outward said housing, and a positioning notch is disposed on said blocking ring for being inserted with said key accurately.

6. The lock with a multiply circled cylinder according to claim 5, wherein two opposite positioning grooves are further disposed on said positioning stem, said sealing cap is disposed with a plurality of locating hooks to locate a U-shaped positioning spring, which further engages with said positioning grooves when said multiply circled cylinder is in a state of locking and said positioning stem is not turned to a unlock position.

7. The lock with a multiply circled cylinder according to claim 5, wherein two pairs of third radial retaining holes are disposed at said inner sleeve corresponding to said first radial retaining holes and said second radial retaining holes respectively such that said inner sleeve is capable of engaging with said front shaft seat and said rear shaft seat respectively with screws when said lock is a rotary lock; and two opposite slots are disposed on said inner sleeve and space apart from said third radial retaining holes an angular distance of 90 degrees such that said inner sleeve is capable of engaging with said front shaft seat and said rear shaft seat in such a way of said first and said second retaining holes aligning with said slots and being secured with screws when said lock is a push-in lock.

8. The lock with a multiply circled cylinder according to claim 3, wherein each of said locking pins is constructed by two cut-short sticks plus a spring placed in between said two cut-short sticks.

9. (canceled)

10. The lock with a multiply circled cylinder according to claim 3, wherein said fourth axial pin holes extend rearward a counter-taper pin hole respectively, said fourth locking pins extend rearward a counter-taper sub-pin section respectively corresponding to said counter-taper pin hole, and a contact switch with an external alarm is installed behind said counter-taper pin hole to emit a warning when said sub-pin projects outward said counter-taper pin hole and touches said contact switch.
